(19) United States
(12) Patent Application Publication
(10) Pub. No.: US 2005/0099886 A1
(43) Pub. Date: May 12, 2005

(54) Static mixing device for homogenising polymer melts

(76) Inventor: Franz Grajewski, Fuchstal (DE)

Correspondence Address: HENRY M FEIEREISEN, LLC, 350 FIFTH AVENUE, SUITE 4714, NEW YORK, NY, 10118, US

(21) Appl. No.: 10/398,421

(22) PCT Filed: Oct. 10, 2001
(86) PCT No.: PCT/EP01/11694

(30) Foreign Application Priority Data
Oct. 19, 2000 (DE) 100 51 925.3

(51) Int. Cl. B01F 5/06

(52) U.S. Cl. 366/336

(57) ABSTRACT

The invention relates to a static mixing device for the homogenization of polymer melts, especially for the homogenization of PVC melts. The device comprises several assembled mixing modules, each module having a tubular housing and mixing elements located therein. The invention is characterized in that the mixing elements have a twisted surface, especially similarly to blades, in that the edge of this surface is firmly connected to the inside of the housing and in that the connection seam is rounded off. The mixing elements are preferably securely welded or soldered to the inside of the housing, and the radius of the connection area is ground. According to an advantageous embodiment, each mixing module is configured of single piece construction and has at least two melt passages (4, 5). Each melt passage has a funnel-like inlet (1, 2) and a funnel-like outlet (6, 7), which are rotated at a certain angle, for example 90°, in relation to each other.

The invention relates to a static mixer for the homogenization of polymer melts in plastics processing machines, in particular for extrusion plants and for PVC polymer melts.

Currently known static mixers have typically mixing segments connected in series to realize a continuous rearrangement of the melt stream and thus to produce a laminar mixing action.

According to a first conventional embodiment (System Thermoprofiler® of LCI International Ltd.) several twisted metal sheets in respective 90° offset relationship are welded to one another. The thus-formed unit can be easily pushed into and pulled out from a suitable cylindrical housing. This system provides a good mixture and is comparably easy to clean. A drawback is, however, the absence of a firm connection between the edges of the metal sheets and the inner housing wall. Therefore, deposits may easily accumulate at these locations during processing of PVC and lead to burning, i.e. this system offers no sufficiently high service life for PVC processing.

According to a second conventional embodiment (EP 0 154 013 B1), several webs of generally cylindrical cross section are securely mounted across in a cylindrical housing in offset relationship. A random number of thus-assembled mixing modules are interconnected and form together a static mixer. Although the arrangement of the webs results in a high degree of mixing, there is, however, the creation of many corners and edges, in particular at contact areas of the webs, that do not permit a PCV-compliant stream and where deposits are encountered time and time again that lead to burning. Therefore, such a system is also unsuitable to provide a sufficiently high service life during PVC processing.

The invention is thus based on the object to provide a static mixer especially for the homogenization of PVC melts, which provides a sufficient mixing of the melt and thus a sufficient degree of homogenization, on one hand, and allows a PVC-compliant stream, on the other hand, to eliminate the afore-stated drawbacks.

This object is attained by a static mixer with the features of claim 1. Advantageous further developments and configurations are set forth in the sub-claims 2 to 7.

The main advantage of the present invention is the presence of only round surfaces within the static mixer so that no dead zones are encountered. Homogenization is improved by the configuration according to the sub-claims 4 ff, because the changing flow cross sections generate in addition a stretching effect in the inlet and a contraction in the outlet. Advantageously, the mixing modules according to the invention, as set forth in sub-claim 6, are “connected in series” in respective 90° offset relationship and put together to form a static mixer. The modular construction has the advantage that the mixing length can be adjusted in an optimum manner to the respective demands. Moreover, the mixing modules are easy to manufacture and further easy to clean.

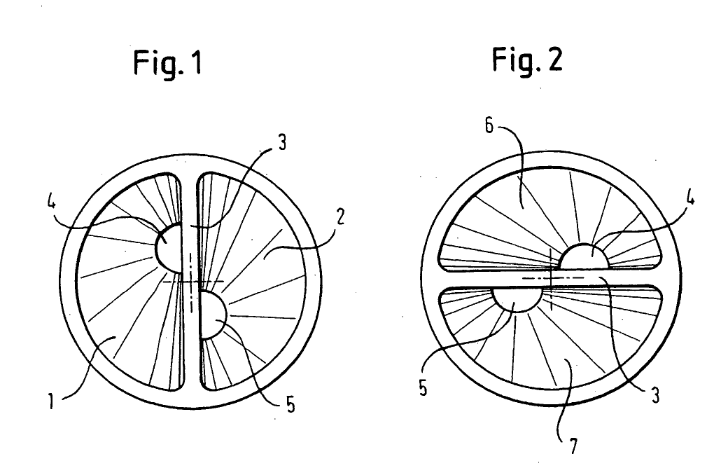

An exemplified embodiment of the invention will now be described in more detail with reference to FIGS. 1 and 2.

FIG. 1 shows a front side (inlet side) of a mixing module according to the invention, and FIG. 2 the rear side. A first funnel-like inlet 1 and a second funnel-like inlet 2 are cut out of a cylindrical block and separated from one another by a remaining web 3. Each inlet 1 and 2 is tapered into the depth of the block toward a respective melt passage 4 and 5. These melt passages 4 and 5 expand again thereafter into funnel-like outlets 6 and 7 on the rear side, whereby the outlet 6 pertains to the inlet 1 and the outlet 7 pertains to the inlet 2. The block is so cut that the inlet and outlet are disposed in 90° offset relationship. Incoming PVC melt is split by the web 3, when impinging upon the mixing module, and rotated by 90°, when flowing therethrough. All surfaces are rounded so that no dead zones are encountered. The flow cross section of both melt streams are not constant so as to additionally realize a stretching effect in the funnel-like inlets 1 and 2, and a contraction in the funnel-like outlets 6 and 7. Several such mixing modules are connected in series and respectively offset hereby at a certain angle relative to one another. At an angular offset of 90°, contacting webs of two mixing modules thus extend perpendicular to one another. The number of mixing modules combined to form a static mixer is dependent on the situation at hand so that an optimum mixer length can be adjusted thanks to the modular construction. Moreover, the mixing modules according to the invention are easy to clean.

### List of Reference Characters

1 first funnel-like inlet
2 second funnel-like inlet
3 web
4 first melt passage
5 second melt passage
6 first funnel-like outlet
7 second funnel-like outlet

1-7. (canceled)

8. A mixing module for the homogenization of polymer melts, comprising a housing having at least two melt channels extending from one end of the housing to another end of the housing and separated by a web, wherein each of the melt channels has a funnel-like inlet extending from one of the ends of the housing, a funnel-like outlet extending to the other one of the ends of the housing, and a melt passage extending between the funnel-like inlet and the funnel-like outlet.

9. The mixing module of claim 8, wherein the inlet and the outlet are rotated to one another.

10. The mixing module of claim 8, wherein the inlet and the outlet are rotated by 90° in relation to one another.

11. The mixing module of claim 8, wherein the housing has a length and a diameter, wherein a ratio of length to diameter is about 1 to 2.

12. A static mixing device for the homogenization of polymer melts, in particular for the homogenization of PVC melts, comprising a plurality of mixing modules, each mixing module having a housing with at least two melt passages, wherein each melt passage has a funnel-like inlet extending from one housing end, and a funnel-like outlet extending to another housing end.

13. The static mixing device of claim 12, wherein the mixing modules are assembled in circumferential direction in offset relationship from mixing module to mixing module.

14. The static mixing device of claim 12, wherein the mixing modules are assembled in circumferential direction in 90° offset relationship from mixing module to mixing module.

15. The static mixing device of claim 12, wherein each of the mixing modules is made of one piece.
